(19) United States
(12) Patent Application Publication
(10) Pub. No.: US 2016/0245744 A1
(43) Pub. Date: Aug. 25, 2016

(54) LIGHT DELAYING APPARATUS, LIGHT DELAYING METHOD, AND MEASURING APPARATUS USING LIGHT DELAYING APPARATUS

(71) Applicant: CANON KABUSHIKI KAISHA, Tokyo (JP)

(72) Inventor: Takeaki Itsuji, Hiratsuka-shi (JP)

(21) Appl. No.: 15/008,861

(22) Filed: Jan. 28, 2016

(30) Foreign Application Priority Data
Feb. 20, 2015 (JP) 2015-031663

(51) Int. Cl. G01N 21/3586; G01J 3/42; G02B 17/02; G01D 5/347; G02B 26/06

(52) U.S. Cl. CPC G01N 21/3586; G01D 5/3473; G02B 26/06; G02B 17/023; G01J 3/42

(57) ABSTRACT

A light delaying apparatus comprises: a first reflector moving along a circumference defined and turning back the light along an axis parallel to an optical axis of the light incident on the first reflector; a second reflector configured to reflect the light turned back by the first reflector such that to be coaxial with the optical axis of the light turned back by the first reflector; and an angular encoder configured to, in order to detect the position of the first reflector on the circumference, include reading patterns in which at least a part of intervals between boundaries of the reading patterns is arranged irregularly, wherein the interval between the boundaries of the reading patterns corresponds to an adjusted quantity of the light delay converted from a time interval during which a time domain response of an electromagnetic wave is measured by using the light reflected by the second reflector.

### BACKGROUND OF THE INVENTION

1. Field of the Invention

The present invention relates to a rotation-type light delaying apparatus, a light delaying method, and a measuring apparatus using the light delaying apparatus.

2. Description of the Related Art

When it is difficult to perform measurement in real time by using an apparatus for measuring a response in a high-speed time domain, a techniques is used, in which a time domain of a response to be measured is divided by using a signal having a time domain sufficiently shorter than the time domain of the response, and thereby the response is measured in the time domain. This sufficiently short signal is referred to as a sampling signal, and the technique, in which a response is measures in a time domain by dividing the time domain of the response, is also referred to as sampling measurement.

Typically, a terahertz wave is an electromagnetic wave having arbitrary frequency band components within the range from 0.03 THz to 30 THz, and a response in the time domain of the terahertz wave may be measured by using the sampling measurement. Especially, an apparatus which measures a terahertz wave in the time domain is referred to as a THz-TDS (THz-Time Domain Spectroscopy) apparatus. In the THz-TDS apparatus, a terahertz wave pulse reaching a terahertz wave detector is sampled and measured by light pulses having a pulse width from several tens to several hundred femtoseconds. At this time, the time difference between the terahertz wave reaching the terahertz wave detector and the light pulse is adjusted by changing the optical path length of the light pulse reaching the terahertz wave detector, and thereby the time domain response of the terahertz wave pulse is measured. The apparatus for changing the optical path length (light delaying apparatus) is an apparatus which adjusts the time difference by changing the optical path length of the light pulse.

In order to perform the sampling measurement at high speed, it is necessary that the speed (also referred to as sweep rate) of changing the optical path length of the light pulse, the speed being required for measuring the time domain response of the terahertz wave pulse, is increased in the light delaying apparatus. As a method to solve the problem, Japanese Patent Application Laid-Open No. 2013-33099 discloses a configuration in which turning back mirrors are respectively installed at positions of a distance R from the center of a rotary table, and the turning back mirrors are rotated. The rotation angle θ of the turning back mirror, and the change of the optical path length ΔL have the relationship of ΔL=4 R sin θ, and hence the change quantity in the optical path length is calculated by monitoring the rotation angle θ.

In the THz-TDS apparatus, for example, an obtained time waveform of a time domain response is subjected to Fourier transform, so that frequency spectrum information is obtained. In this case, the time interval (sampling interval) of the plurality of data forming the time waveform needs to be fixed. Therefore, data are acquired for each change quantity (also referred to as unit delaying quantity δ L) of the optical path length of the pulse light, which quantity corresponds to the time interval of data forming the time waveform.

Here, in the techniques disclosed in Japanese Patent Application Laid-Open No. 2013-33099, the change quantity of the optical path length with respect to the rotation angle θ is non-linearity. Further, in general, an angular encoder detecting the rotational angle θ is provided with a fixed-pitch scale, and hence the minimum angle read by the scale is fixed. Therefore, in the THz-TDS apparatus, in the configuration in which the unit delaying quantity δL between adjacent data is fixed, the nonlinearity of the change quantity of the optical path length with respect to the rotation angle θ needs to be compensated. To this end, for example, the apparatus acquires data at a time interval shorter than the time interval of the data configuring the time waveform (also referred to as oversampling). Further, data for each delaying quantity approximated to the unit delaying quantity δL are extracted from the acquired data group, to configure a time waveform. For this reason, in the apparatus, the quantity of data to be handled is large.

Further, when the adjusted quantity of the light delay for data acquisition by oversampling is deviated from the integral multiple of the unit delaying quantity δL, a momentary value (measured value) of a time domain response corresponding to the adjusted quantity of light delay is not detected, and hence data missing may occur. In the measurement in which measured data are arranged in time series as in the measurement of terahertz wave in time domain, when data missing occurs, the measured value at the time of occurrence of data missing is unknown, and hence an abrupt signal change may occur in data adjacent to the missing data. For this reason, the measurement accuracy may be deteriorated.

### SUMMARY OF THE INVENTION

According to an aspect of the present invention, a light delaying apparatus providing a light delay, the light delaying apparatus comprises: a first reflector configured to move along a circumference defined by a rotation center and a first radius and turn back the light along an axis parallel to an optical axis of the light incident on the first reflector; a second reflector configured to reflect the light turned back by the first reflector such that to be coaxial with the optical axis of the light turned back by the first reflector; and an angular encoder configured to, in order to detect the position of the first reflector on the circumference, include reading patterns in which at least a part of intervals between boundaries of the reading patterns is arranged irregularly, wherein the interval between the boundaries of the reading patterns corresponds to an adjusted quantity of the light delay converted from a time interval during which a time domain response of an electromagnetic wave is measured by using the light reflected by the second reflector.

Further features of the present invention will become apparent from the following description of exemplary embodiments with reference to the attached drawings.

### BRIEF DESCRIPTION OF THE DRAWINGS

FIG. 1A is a schematic view for describing a configuration of a light delaying apparatus of embodiment 1.

FIG. 1B is a sectional view along the line 1B-1B in FIG. 1A showing the configuration of the light delaying apparatus of embodiment 1.

FIG. 2 is a view for describing an example of arrangement of a read pattern of an angular encoder of embodiment 1.

FIG. 3A is a view for describing a reading pattern of A phase of embodiment 1.

FIG. 3B is a view for describing reading patterns of B phase, C phase, and D phase of embodiment 1.

FIG. 3C is a timing chart of output of the reading portion of each of the phases of embodiment 1.

FIG. 3D is a view showing an output of the signal output portion of embodiment 1.

FIG. 3E is a view showing a relationship between the number of data n and the delaying quantity ΔL.

FIG. 4A is a schematic view for describing a configuration of a light delaying apparatus of embodiment 2.

FIG. 4B is a sectional view along the line 4B-4B in FIG. 4A showing the configuration of the light delaying apparatus of embodiment 2.

FIG. 5A is a schematic view for describing a configuration of a light delaying apparatus of embodiment 3.

FIG. 5B is a sectional view along the line 5B-5B in FIG. 5A showing the configuration of the light delaying apparatus of embodiment 3.

FIG. 6 is a view for describing another configuration of the reference position adjusting mechanism of embodiment 3.

FIG. 7A is a view for describing an example of a configuration of a light delaying apparatus of embodiment 4.

FIG. 7B is a view for describing another example of the configuration of the light delaying apparatus of embodiment 4.

FIG. 8 is a view for describing an example of a configuration of an apparatus which measures a response of a terahertz wave of embodiment 5.

FIG. 9 is a view for describing another example of the configuration of the apparatus which measures a response of probe light of embodiment 5.

### DESCRIPTION OF THE EMBODIMENTS

Preferred embodiments of the present invention will now be described in detail in accordance with the accompanying drawings.

As described above, in the changing apparatus (light delaying apparatus) using a rotary table, the change quantity of the optical path length is not linear with respect to the rotation angle θ. Further, in general, the angular encoder for detecting the rotation angle θ has a fixed-pitch scale, and hence the minimum angle read by the scale is fixed. Therefore, as in the THz-TDS apparatus, in the configuration in which the unit delaying quantity δL between adjacent data is fixed, it is necessary to compensate for the nonlinearity of the change quantity of the optical path length with respect to the rotation angle θ. To this end, for example, when the oversampling for acquiring data of a time waveform is performed with a time interval shorter than the time interval of the data forming the time waveform, data quantity is increased.

Also, even when the oversampling is performed, there is a possibility that the data missing occurs. Further, there is a concern that, when the measured data are averaged, the SN ratio is different between adjacent data. In the case where there is data missing, when the results obtained by a plurality of measurements are integrated, the number of data may be different at each of the positions on the time axis, and thereby the SN ratio is different at each of the positions on the time axis. The effects of these problems appear, for example, in a manner that a pseudo-spectrum is superimposed on the original spectrum at the time when a time waveform is converted into a frequency spectrum. This may cause deterioration of the measurement accuracy.

In the following embodiments, an angular encoder, having reading patterns formed thereon so that intervals between the boundaries (scales) of the patterns are arranged irregularly, and sampling using pulse light is performed to detect a position of a first reflector on a circumference, which position corresponds to a measurement region of a time domain response of an electromagnetic wave to be measured by the sampling. The first reflector generates a light delay between pulse light as incident light (incoming light) and pulse light as emitted light (outgoing light). Further, the interval between boundaries of the reading patterns corresponds to the adjusted quantity of the light delay, which quantity is converted from the time interval for measuring the time domain response of the electromagnetic wave by using the emitted light. That is, the reading patterns are formed to detect a plurality of positions of the first reflector, which respectively correspond to the adjusted quantities of the plurality of light delays of the pulse light, and also respectively correspond to the time intervals between the times when the plurality of data configuring the response are obtained. Thereby, the information on the movement position of the first reflector is converted into the information on the adjusted quantity of the light delay of pulse light (the change quantity of optical path length or the time delaying quantity).

The plurality of predetermined times can be arbitrary times, but are typically set in units of the time interval corresponding to the unit delaying quantity. The reading patterns are formed to detect a plurality of positions of the first reflector, which respectively correspond to the adjusted quantities of the plurality of light delays in units of the unit delaying quantity. A trigger signal corresponding to the detection of each of the plurality of positions of the first reflector is output, and the response in the time domain is measured in synchronization with the trigger signal, so that a plurality of data configuring the response can be obtained for each of the unit delaying quantity. For this purpose, it is necessary that the change of the light delay quantity with respect to the change of the position of the first reflector is not linear, and hence, at least part of the intervals between boundaries of the reading patterns is arranged irregularly.

### Embodiment 1

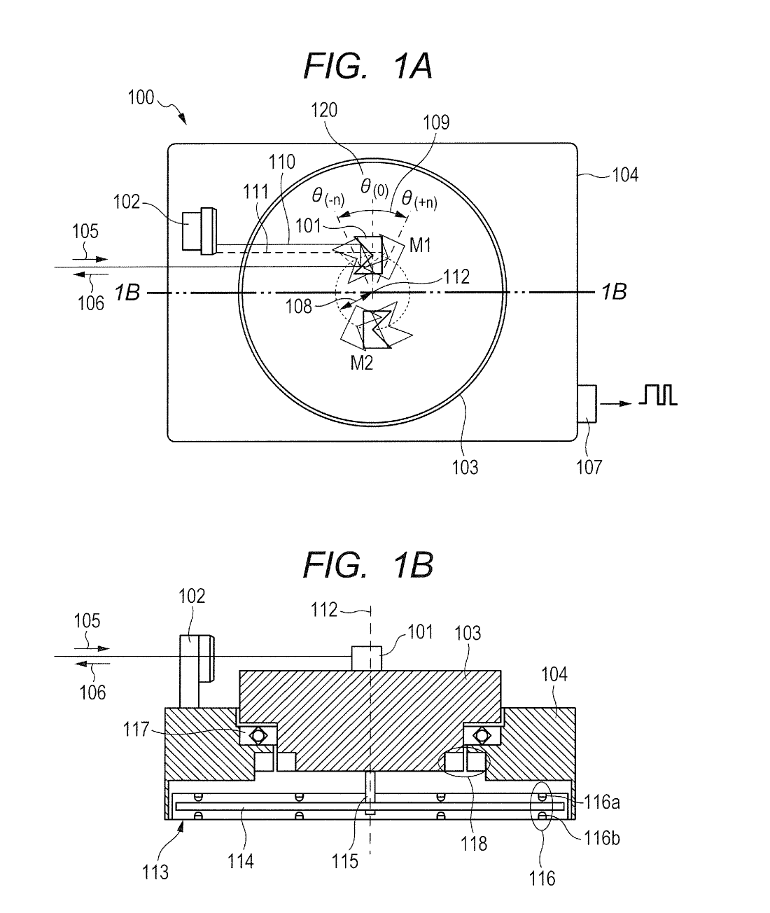

Embodiment 1 will be described with reference to the drawings. FIG. 1A is a schematic view for describing a configuration of a light delaying apparatus 100 of the present embodiment, and FIG. 1B is a sectional view along line 1B-1B in FIG. 1A showing the light delaying apparatus 100. The light delaying apparatus 100 is preferably used in an apparatus which measures a time domain response of an electromagnetic wave by sampling using pulse light. Incident light (incoming light) 105 is light incident on the light delaying apparatus 100. Emitted light (outgoing light) 106 is light emitted from the light delaying apparatus 100. Each of the incident light 105 and the emitted light 106 is pulse light. The light delaying apparatus 100 adjusts light delaying quantity between the incident light 105 and the emitted light 106.

A first reflector 101 is a portion which allows the incident light 105 to be turned back along the axis parallel to the optical axis of the incident light 105. The parallel axes are, for example, a first optical path 110 and a second optical path 111. A turning back optical system using a plurality of mirrors, or a prism can be applied as the first reflector 101. The first reflector 101 can be moved along a circumference defined by a rotation center 112 and a first radius 108. In the present embodiment, two first reflectors 101 (M1 and M2) are provided, but the number of the first reflectors 101 is not limited to two. The number of the first reflectors 101 may be one or two or more. In this specification, the position of the first reflector 101 on the position on the circumference defined by the first radius 108 is represented by the angle θ about the rotation center 112.

The first reflector 101 is arranged on a rotary table 103. The rotation center of the rotary table is the same as that of the rotation center 112. The first reflector 101 is moved along the circumference defined by the first radius 108 in accordance with the rotation of the rotary table 103. The rotary table 103 is supported by a casing 104 via a guide 117. The guide 117 defines the moving direction of the rotary table 103. The rotary table 103 is rotated along the guide 117 by receiving force from a motor 118 installed between the rotary table 103 and the casing 104.

A second reflector 102 is a portion by which turned back pulse light turned back by the first reflector 101 is reflected in the direction coaxial to the optical axis of the turned back pulse light. The second reflector 102 is fixed and installed in the casing 104. For example, the second reflector 102 is configured by a plane mirror. The pulse light reflected by the second reflector 102 is again output, as the emitted light 106, from the light delaying apparatus 100 via the first reflector 101. At this time, the optical path, through which the incident light 105 reaches the second reflector 102 via the first reflector 101, is the same as the optical path through which the light reflected by the second reflector 102 is output as the emitted light 106 via the first reflector 101, and hence the incident light 105 and the emitted light 106 are coaxial to each other.

When the first reflector 101 is moved, the optical path of the pulse light from the first reflector 101 to the second reflector 102 is changed as shown in FIG. 1A. In FIG. 1A, the optical paths between the position θ₍₀₎ and the position θ₍ᵢₙ₎ are respectively shown as the first optical path 110 and the second optical path 111. The light delaying apparatus 100 delays the pulse light by using the difference in the optical path length between the first optical path 110 and the second optical path 111. Here, the position θ₍₀₎ is the position where the incident light 105 is turned back at a right angle in the direction of the second reflector 102 by the first reflector 101. In the present embodiment, the position θ₍₀₎ is represented as a first reference position 120. When the first reflector 101 is moved to the position θ₍₋ₙ₎ on the basis of the position θ₍₀₎ the light delaying quantity is reduced, while when the first reflector 101 is moved to the position θ₍₊ₙ₎ on the basis of the position θ₍₀₎, the light delaying quantity is increased. Here, the adjusted quantity of the light delay is obtained by expression (1). In expression (1), ΔL is the adjusted quantity of light delay, and R is the first radius 108. When θ=0, the first reflector 101 is arranged at the position θ₍₀₎.

ΔL=4R sin θ (1)

When the absolute value |ΔL| of the adjusted quantity of the light delay between θ₍₀₎ and θ₍₋ₙ₎ is equal to the absolute value |ΔL| of the adjusted quantity of the light delay between θ₍₀₎ and θ₍₊ₙ₎, the pulse light turned back by the first reflector 101 arranged at the position θ₍₋ₙ₎, and the pulse light turned back by the first reflector 101 arranged at the position θ₍₊ₙ₎ are emitted to the same position of the second reflector 102 respectively via the first optical path 110 and the second optical path 111. In addition, according to expression (1), the adjusted quantity of the light delay at the time when the first reflector 101 is arranged at position θ₍₀₎ can be expressed as ΔL=0. In other words, the position, at which the absolute value of the adjusted quantity of the light delay becomes minimum, is referred to as the first reference position 120 (position θ₍₀₎).

Here, “adjusted quantity of light delay” is defined as an adjusted quantity of light delay relative to the light delay of light reflected at the first reference position 120. In addition, “light delaying quantity” represents an absolute delaying quantity of the apparatus including the light delaying apparatus 100. Further, in the present embodiment, the region where the light delay adjustment is performed is referred to as a measurement region 109. In the present embodiment, the measurement region 109 is a region from the position θ₍₋ₙ₎ to the position θ₍₊ₙ₎. In a measuring apparatus incorporating therein the light delaying apparatus 100, the measurement of response is performed in the measurement region 109.

The rotational position of the first reflector 101 is detected by an angular encoder 113. The angular encoder 113 is configured by including a shaft 115, a reading portion 116 (including a light emitting portion 116a and a light receiving portion 116b), and a code disk 114. Here, the light receiving portion 116b receives transmitted light, and hence the light emitting portion 116a and the light receiving portion 116b are respectively located on both sides of the code disk 114 so as to face each other. When the light receiving portion 116b receives reflected light, the light emitting portion 116a and the light receiving portion 116b are arranged on the same side of the code disk 114. Light from the light emitting portion 116a is emitted to the code disk 114 via a slit, or the like.

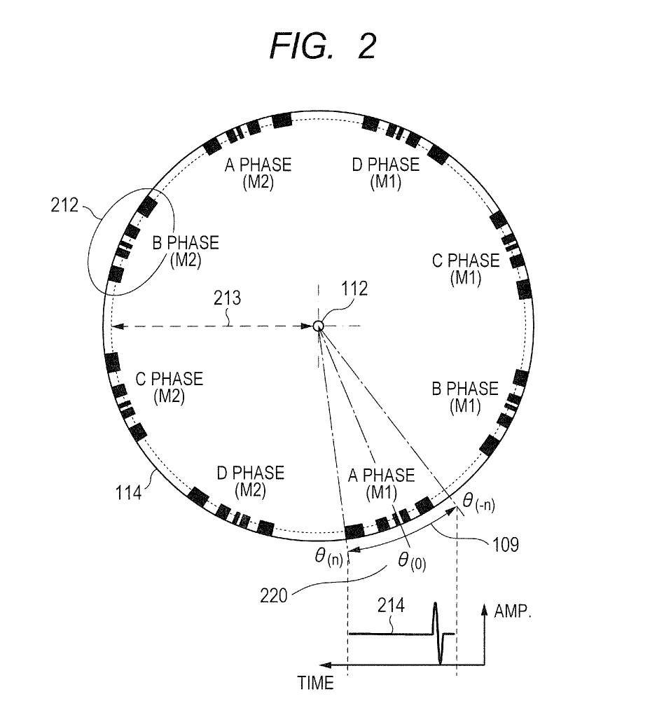

The shaft 115 is connected to the rotary table 103, to transmit the rotation of the rotary table 103 to the angular encoder 113. The code disk 114 is connected to the shaft 115, and the rotation of the shaft 115 is transmitted to the code disk 114, so that the code disk 114 is rotated. The code disk 114 has, as shown in FIG. 2, reading patterns 212 which reflect or transmit reading light emitted from the light emitting portion 116a of the reading portion 116. For example, the code disk of FIG. 2 is a member capable of transmitting the reading light, and the reading light is reflected by the reading patterns 212 (black portions in FIG. 2). The code disk 114 is arranged to be sandwiched between the light emitting portion 116a and the light receiving portion 116b of the reading portion 116, and hence the light receiving portion of the reading portion 116 detects the reading light transmitted through the reading pattern 212.

More specifically, the angular encoder 113 detects the position of the first reflector 101 on the basis of the position corresponds to the measurement region 109 of FIG. 2, in which region the time domain response is measured. To this end, the angular encoder 113 has at least one set of reading patterns 212 so that intervals between the boundaries of the reading patterns 212 are arranged irregularly. The reading portion 116 detects reflected or transmitted reading light from the reading patterns 212 to obtain a rotational position of the first reflector 101. By using the output of the reading portion 116, the light delaying apparatus 100 outputs a trigger signal, for example, for each unit delaying quantity δL from a signal output portion 107. An apparatus for measuring the time domain response, described below, performs sampling measurement in synchronism with the trigger signal. For this reason, it is necessary that the intervals between the boundaries of the reading patterns 212 correspond to the unit delaying quantity 8L of pulse light converted from time intervals of a plurality of data forming the time domain response. That is, the intervals between the boundaries of the reading patterns 212 (that is, shapes of transmitting or reflecting portions) are formed so that data can be obtained for each unit delaying quantity δL by performing the measurement in synchronism with the trigger signal. To this end, since, as described above, the change quantity of the optical path length is nonlinear with respect to the change quantity of the rotation angle θ of the first reflector 101, it is necessary that a part of the intervals between the boundaries of the reading patterns 212 is arranged irregularly.

The unit delaying quantity δL which is determined by observation of the rotation angle θ of the first reflector performed by using the reading patterns, and the acceptable range of the error of the time interval described above depend on an apparatus using the light delaying apparatus including the angular encoder. For example, the acceptable ranges are expressed as follows.

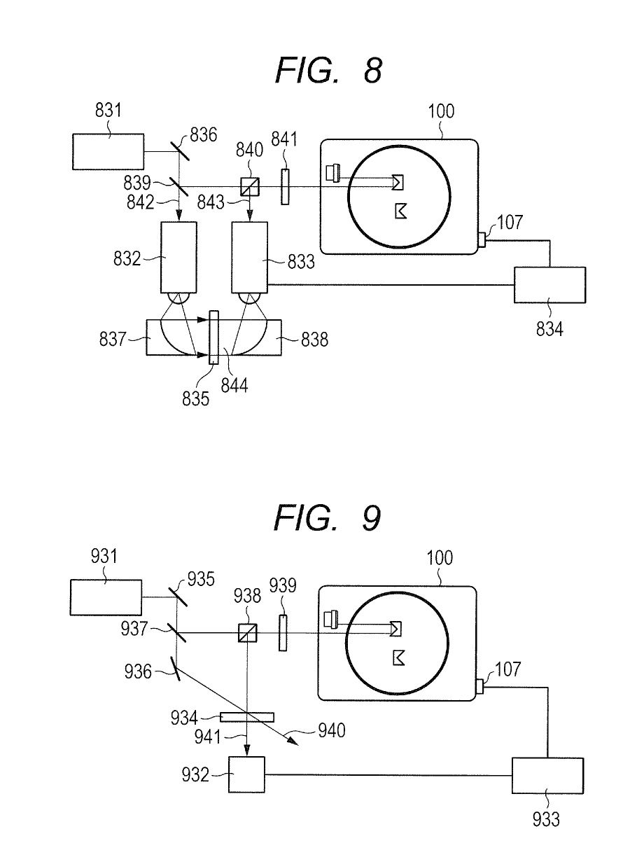

(1) When the response is represented as a form of a terahertz wave having a maximum frequency F (see the embodiment shown in FIG. 8 described below), it is preferred that, on the basis of the sampling theorem, the sampling is performed at a frequency more than twice the frequency of the terahertz wave. Therefore, the acceptable ranges of the above-described error are expressed as A<1/(2F) and B<C/(2F), where the time accuracy is represented by A and the accuracy of delaying quantity is represented by B, and the optical constant is represented by C, and hence it is necessary to configure the shapes of the reading patterns and the like, having the accuracy satisfying these conditions. The position accuracy D at the time when the turning back optical system is used is expressed as D<C/(4F).

(2) When a transient response is observes in the time resolution T (see the embodiment in FIG. 9 describe below), the acceptable ranges are expressed as A<T, B<CA and D<CA/2.

(3) When the response is provided as a tomography related to observation of an object (see the embodiment in FIG. 8 describe below), the acceptable ranges are expressed as B<E and D<E/2, where the spatial resolution is represented by E.

FIG. 2 is a view showing an example of the arrangement of the sets of the reading patterns 212 arranged on the code disk 114. In FIG. 2, each set of a plurality of the reading patterns 212 is drawn so as to be formed at a different position, but has the same arrangement pattern of the reading patterns 212. However, each set of the reading patterns 212 does not necessarily have the same patterns. Each set of the reading patterns 212 of FIG. 2 is arranged on the circumference defined by a second radius 213 around the rotation center 112. In FIG. 2, a total of eight sets of the reading patterns 212 are respectively arranged at predetermined points, and the eight sets are divided into two groups, so that each group of the four sets (A phase, B phase, C phase and D phase) is made to correspond to each of M1 and M2 of the first reflector 101. The phases of B phase, C phase and D phase are shifted from the phase of A phase as the first phase (from which the other patterns are shifted), and hence the reading resolution can be improved by combining the signals of each of the phases, which are read by the reading portion 116. For example, as shown in FIG. 2, an eight times multiplied signal at the maximum can be obtained by combining the read signals of the four phases.

The reading resolution of the reading signals depends on the intervals between the boundaries of the reading patterns 212, and the reading resolution is improved by reducing the intervals between the boundaries of the reading patterns 212. However, the processing of the intervals between the boundaries of the reading patterns 212 has a limited precision (for example, several μm), and hence it is difficult to indefinitely reduce the intervals. As a result, in order to improve the reading resolution, it is necessary to increase the radius at the positions at which the reading patterns 212 are arranged (the second radius 213 in FIG. 2). Here, that the number of multiplications of the reading signal is increased means that the intervals between the boundaries of the phases of the reading patterns 212 are increased to a level required for obtaining the same reading resolution. As a result, the radius at the positions at which the reading patterns 212 are arranged (the second radius 213 in FIG. 2) can be reduced, and also the size of the code disk 114 can be reduced. For this reason, it is also possible to reduce the size of the angular encoder 113. It should be noted that the number of phases of the sets of the reading patterns 212 is not limited to the above described number. For example, the number of phases of the set of the reading patterns 212 may be one (only A phase).

Each set of the reading patterns 212 has reading patterns in which a part of the intervals between the boundaries of the reading patterns is arranged irregularly in order to detect the angular position of the first reflector 101 at the position of the code disk 114 corresponding to the measurement region 109 in which a time domain response (a signal output 214 of an external apparatus of FIG. 2) is measured. Each set of the reading patterns 212 has a reference position, and in the present embodiment, this reference position is referred to as a second reference position 220. The second reference position 220 of each set of the reading patterns 212 represents the position at which the first reflector 101 is arranged at the position θ₍₀₎. Each set of the reading patterns 212 individually has the second reference position 220.

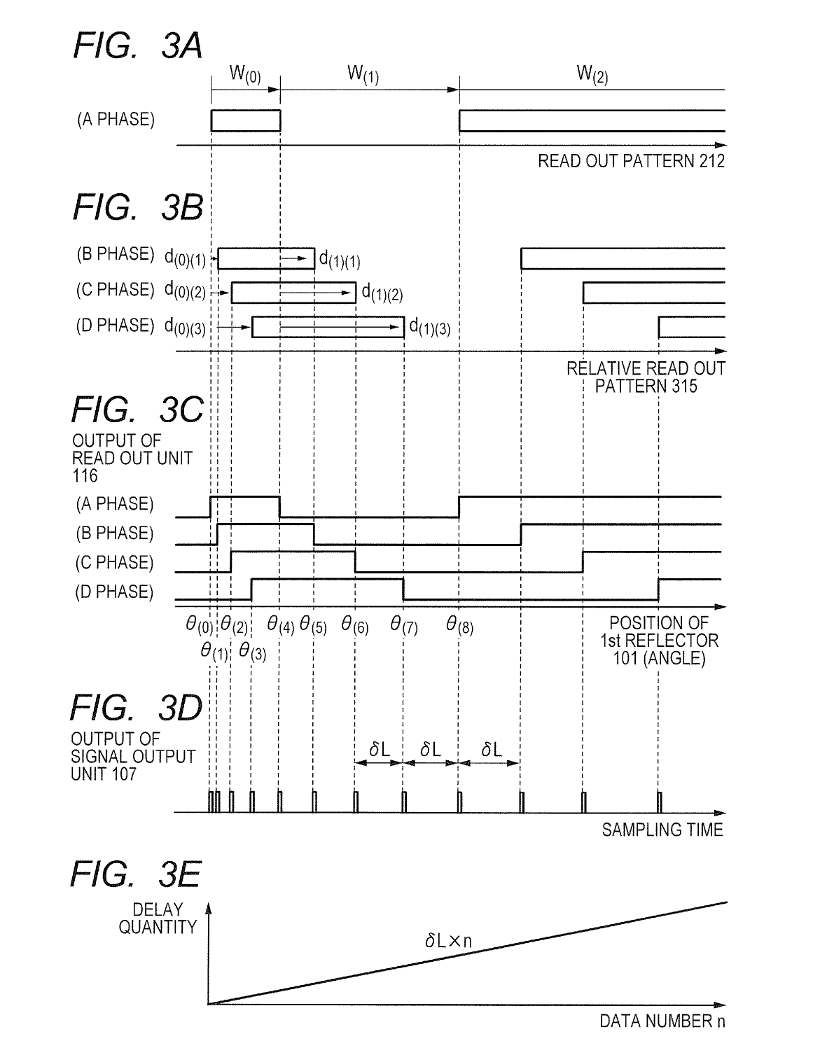

FIG. 3A is a view for describing the reading pattern of the A phase of the present embodiment, and is a view linearly showing the reading patterns 212 of the A phase. FIG. 3B is a view for describing the reading patterns of B phase, C phase and D phase of the present embodiment, and is a view in which the reading patterns 212 of B phase, C phase and D phase are linearly arranged side by side for simplicity of explanation. The horizontal axis of FIG. 3A and FIG. 3B represent the position. Here, the reading patterns 212 other than the reading patterns of A phase are collectively referred to as relative reading patterns 315. In fact, the reading pattern is defined on the basis of the second reference position (position θ₍₀₎) of each set of the reading patterns 212.

When the above-described expression (1) is modified, the position θ can be expressed by the following expression (2). It should be noted that, for simplicity of explanation, here, the range of the position θ on the circumference is limits to a region from θ₍₀₎ to θ₍₊ₙ₎. Here, δL represents the unit delaying quantity, and R represents the first radius 108. Further, n represents the number of a plurality of data forming a response.

θ₍ᵢ₎=sin⁻¹{((iδL)/(4R)}i=0,1, . . . ,n (2)

At this time, on the basis of the reference position, a pattern interval W between the boundaries of the reading patterns 212 of the A phase is defines as the following expression (3). Here, r represents the second radius 213 defining the formation position on the code disk of the reading patterns, and x represents the number of phases of the sets of the reading patterns 212 (four in the present embodiment).

W₍ⱼ₎=(πr/180)·(θ₍ₓ₍ⱼ₊₁₎₎−θ₍ₓⱼ₎)j=0,1, . . . ,(n/x−1) (3)

As described above, in the present embodiment, the reading patterns of each of B phase, C phase and D phase, which patterns are relative reading patterns 315, are arranged so as to be shifted from the reading patterns 212 of A phase. Specifically, as shown in FIG. 3B, with respect to the position of the boundary of the pattern of A phase, which pattern is defined by the interval W, the boundaries of the patterns of the other phases are arranged to be shifted at an interval d. The relative interval d is represented by the following expression (4). Here, when m represents a constant, and when the pattern of the first phase is set as A phase, the other phases are set such that B phase is set as m=1, C phase is set as m=2, and D phase is set as m=3.

d₍ⱼ₎₍ₘ₎=(πr/180)·(θ(₍ₓⱼ₊ₘ₎−θ₍ₓⱼ₎)m=1,2, . . . ,x (4)

Here, examples of calculation of θ, d and W of FIG. 3A and FIG. 3B, at the time when δL=2 μm, R (first radius 108)=10 mm, r (second radius 213)=50 mm, the number of phases x=4, and the number of data n=4096, are shown below.

TABLE 1

| Position of first | Relative reading patterns | | Light delaying | |
|---|---|---|---|---|
| reflector 101 | 315 | Reading patterns 212 | quantity dL | |
| θ₍₀₎ 0.00 mdeg | | | 0 | μm |
| θ₍₁₎ 2.86 mdeg | d₍₀₎₍₁₎ 2.500000001 μm | | 2 | μm |
| θ₍₂₎ 5.72 mdeg | d₍₀₎₍₂₎ 5.000000008 μm | | 4 | μm |
| θ₍₃₎ 8.59 mdeg | d₍₀₎₍₃₎ 7.500000028 μm | | 6 | μm |
| θ₍₄₎ 11.45 mdeg | | W₍₀₎ 10.000000066 μm | 8 | μm |
| θ₍₅₎ 14.32 mdeg | d₍₁₎₍₁₎ 2.500000064 μm | | 10 | μm |
| θ₍₆₎ 17.18 mdeg | d₍₁₎₍₂₎ 5.000000158 μm | | 12 | μm |
| θ₍₇₎ 20.05 mdeg | d₍₁₎₍₃₎ 7.500000291 μm | | 14 | μm |
| θ₍₈₎ 22.91 mdeg | | W₍₁₎ 10.00000047 μm | 16 | μm |
| . . . | . . . | . . . | . . . | |
| θ₍₄₀₉₂₎ 11.8060 deg | | W₍₁₀₂₂₎ 10.21589703 μm | 8.184 | mm |
| θ₍₄₀₉₃₎ 11.8090 deg | d₍₁₀₂₃₎₍₁₎ 2.554042411 μm | | 8.186 | mm |
| θ₍₄₀₉₄₎ 11.8119 deg | d₍₁₀₂₃₎₍₂₎ 5.108112098 μm | | 8.188 | mm |
| θ₍₄₀₉₅₎ 11.8119 deg | d₍₁₀₂₃₎₍₃₎ 7.662209070 μm | | 8.190 | mm |
| θ₍₄₀₉₆₎ 11.8119 deg | | W₍₁₀₂₃₎ 10.21633333 μm | 8.192 | mm |

As can be seen from Table 1, in order that the boundary of the pattern is provided for each of the unit delaying quantity δL, the intervals between the boundaries of the reading pattern 212 and of the relative reading patterns 315 are arranged irregularly. Here, a part of the intervals between the boundaries of the reading patterns 212 and of the relative reading patterns 315 may be arranged regularly. For example, when the reading resolution of the delaying quantity is set to an order of 1 μm, it is possible to truncate less than three decimal places of W and d which represent the intervals between the boundaries of the phase of the reading patterns 212 and of the phases of the relative reading patterns 315. In this case, it is seen that, among the example of calculation results shown in table 1, the intervals W and d corresponding to θ₍₀₎ to θ₍₈₎ take the same values for.

FIG. 3C is a timing chart of outputs of the reading portions 116 of the respective phases of the light delaying apparatus 100. The horizontal axis represents the position (angle) of the first reflector 101. In the reading portion 116 of each of the phases, the intensity of detected light is changed at the boundaries of the phases of the reading patterns 212 and of the relative reading patterns 315. Each time when the change of the intensity of light is detected, the reading portion 116 changes its output. The reading portion 116 is configured by combining a transmission type light emitting portion and a light receiving portion. It is considered that, among the reading patterns of FIG. 3A and FIG. 3B, the region surrounded by a square is configured by a light-transmitting material. When light is detected by the light receiving portion of the reading portion 116, the output of the reading portion 116 becomes the HI state. When light is not detected by the light receiving portion, the output of the reading portion 116 becomes the LO state.

FIG. 3D is a view showing outputs of the signal output portion 107 of the light delaying apparatus 100. The horizontal axis represents the time. When the light delaying apparatus 100 is incorporated in the apparatus measuring the response, the horizontal axis represents the sampling timing. Here, a trigger signal is output each time when the output of the reading portion 116 is changed. Specifically, the trigger signal is output in synchronization with the rise and fall of the output of the reading portion 116 provided for each of the phases. As shown in FIG. 3D, the interval between the timings of the trigger signals (quantity expressed in terms of time) corresponds to the unit delaying quantity δL (quantity expressed in terms of optical path length). In this way, the light delaying apparatus detects each of angles θ in Table 1, which correspond to the delaying quantity based on the unit delaying quantity, and outputs a trigger signal at each detection time.

FIG. 3E is a view showing a relationship between the number n of data for sampling and delaying quantity ΔL (quantity expressed in terms of the optical path length). When, in synchronization with the trigger signal output by the signal output portion 107, the measurement is performed by the apparatus which measures a time domain response of an electromagnetic wave, the delaying quantity corresponding to the interval between the trigger signals is the unit delaying quantity δL. Therefore, as shown in FIG. 3E, the number n of data to be measured, and the delaying quantity ΔL are in a proportional relationship, and hence it is possible to obtain the delaying quantity ΔL by counting the number n of data to be measured. Specifically, the relationship is expressed as the delaying quantity ΔL=δ L×n.

In the light delaying apparatus of the present embodiment, by using the reading patterns 212 in which a part of the intervals between the boundaries in the reading patterns 212 are arranged irregularly, information on a moving angle of the first reflector 101 is converted into information on the delaying quantity of pulse light (quantity expressed in terms of the optical path length) and output. Therefore, the delaying quantity of the pulse light can be directly read, and hence the measure for compensating the nonlinearity described above is not needed, so that the general versatility of the light delaying apparatus can be improved. The light delaying apparatus of the present embodiment provides the advantage that the delaying portion of the rotary system is used, and that the speed of changing or adjusting the optical path length can be improved. In addition, it is unnecessary to acquire data at an interval shorter than the time interval of data, and hence the quantity of data can be decreased. Therefore, it is possible to obtain advantages, such as that the processing speed can be improved, and that the handling of data (storing, and the like) becomes easy.

### Embodiment 2

Embodiments 2 will be described with reference to the accompanying drawings. The present embodiment is a modification of embodiment 1. It should be noted that description of the parts in common with the previous description will be omitted. In the above-described description, the first reflector 101 has the first reference position 120 (FIG. 1A), and each of the phases of the reading patterns 212 has the second reference position 220 (FIG. 2) with respect to the first reference position 120. Further, in the reading pattern 212, the interval W and the relative interval d are defined on the basis of the second reference position 220. In other words, the angular encoder 113 having the reading patterns 212 is an encoder having an absolute position. Therefore, positioning of the first reference position 120 and the second reference position 220 is important.

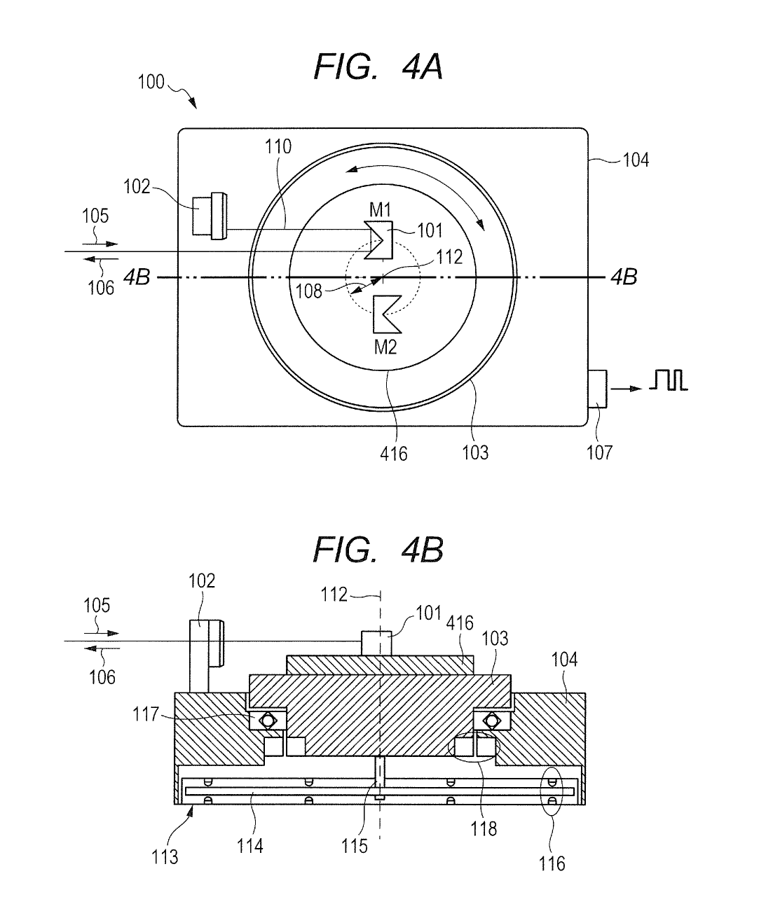

FIG. 4A is a schematic view for describing a configuration of a light delaying apparatus of the present embodiment, and FIG. 4B is a sectional view along the line 4B-4B in FIG. 4A. The light delaying apparatus of the present embodiment includes a position adjusting mechanism 416 which relatively positions the first reference position 120 of the first reflector 101 arranged on a predetermined circumference, and the second reference position 220 of the reading patterns 212. Specifically, the position adjusting mechanism 416 is a rotary type positioning mechanism, and is installed on the rotary table 103. For example, the rotary type positioning mechanism is configured by a circular guide and a table, and has a configuration in which the table can be rotated along the circular guide. The rotation angle of the table is adjusted, for example, by a micrometer. The micrometers may be a manual type micrometer or an automatic type micrometer. Further, the adjustment of the rotation angle of the table of the rotary type positioning mechanism may be performed by using a motor. In addition, the first reflector 101 is installed on the position adjusting mechanism 416. The rotation center of the position adjusting mechanism 416 is the same as the rotation center 112 of the rotary table 103.

By the position adjusting mechanism 416, the adjusting axis in the rotation direction of the first reflector 101 can be increased. Thereby, the position adjusting mechanism 416 can perform positioning of the first reference position 120 and the second reference position 220 independently from the rotation of the rotary table 103. When the rotary table 103 is rotated, the first reflector 101 is rotated integrally with the position adjusting mechanism 416. It should be noted that, in the present embodiment, the position adjusting mechanism 416 is installed on the side of the rotary table 103, and the first reflector 101 is moved in the rotation direction. However, the position adjusting mechanism 416 may also be installed on the side of the code disk 114 so as to adjust the rotational position of the code disk 114 having the reading patterns 212. In this case, the code disk 114 is fixed to the shaft 115 via the position adjusting mechanism 416, and the position adjusting mechanism 416 can perform relative positioning of the first reference position 120 and the second reference position 220 independently of the rotation of the shaft 115. When the shaft 115 is rotated, the code disk 114 is rotated integrally with the position adjusting mechanism 416.

In the light delaying apparatus of the present embodiment, adjustment of the first reference position of the first reflector 101 and the second reference position of the reading pattern 212 can be performed by the position adjusting mechanism 416. Therefore, in this rotary type light delaying apparatus, the quantity of data that are handled, and the degradation of the measurement accuracy can be suppressed. Further, it is possible to improve the accuracy when information on the moving angle of the first reflector 101 is converted into information on the delaying quantity of pulse light.

### Embodiment 3

Embodiment 3 will be described with reference to the accompanying drawings. The present embodiment is a modification of embodiment 2. Specifically, the configuration of a position adjusting mechanism in embodiment 3 is different from that in embodiment 2. It should be noted that description of the parts in common with the previous description will be omitted.

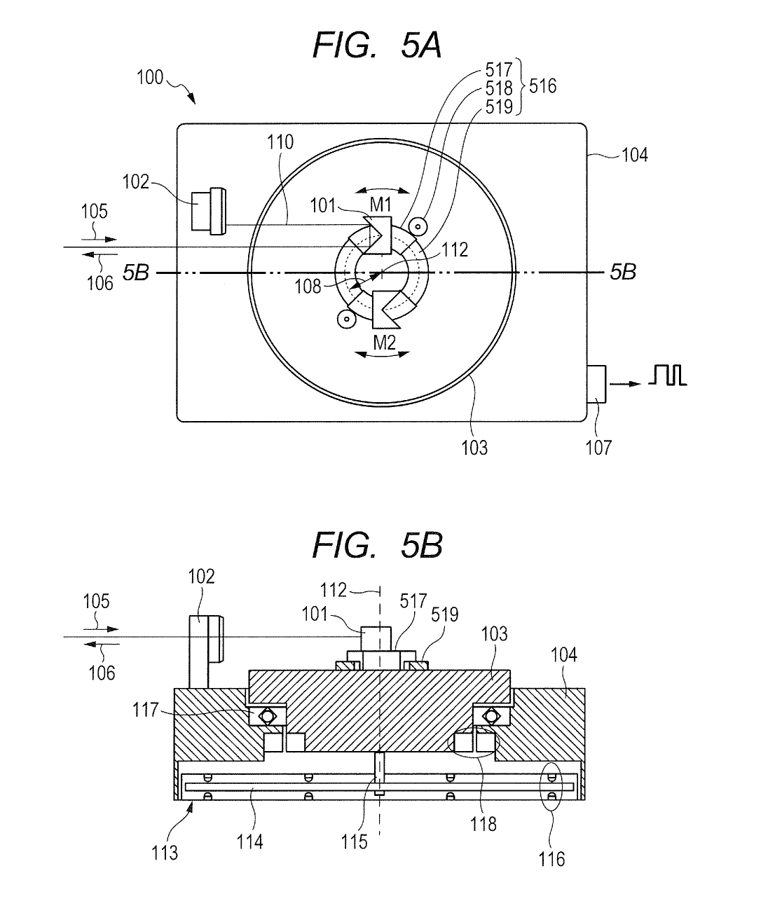

FIG. 5A is a schematic view for describing a configuration of a light delaying apparatus of the present embodiment, and FIG. 5B is a sectional view along the line 5B-5B in FIG. 5A showing the light delaying apparatus. A position adjusting mechanism 516 of the present embodiment is a mechanism which independently adjusts a plurality of adjustment places at which the first reference position 120 and the second reference position 220 are positioned. Specifically, M1 and M2, each of which is the first reflector 101, are independently adjusted. The position adjusting mechanism 516 is configured by movable bodies 517, gears 518 and a circular rail 519. Among the plurality of movable bodies 517 installed on the circular rail 519, M1 as the first reflector 101 is installed at one of the movable body 517, and M2 as the first reflector 101 is installed at the other of the movable bodies 517. The gears 518 are arranged so as to be in contact with the movable bodies 517. The movable body 517 has a gear-cutting structure in which the rotational force of the gear 518 is converted into linear direction force, and the movable body 517 is moved on the circular rail 519 in accordance with the rotation of the gear 518. The center of the circular rail 519 is the same as the rotation center 112 of the rotary table 103. The first reflector 101 is installed in the movable body 517, and hence the first reflector 101 is moved integrally with the movable body 517. With these configurations, the position adjusting mechanism 516 can independently perform positioning of each of M1 and M2 by using a plurality of combinations with the first reference position 120 and the second reference position 220.

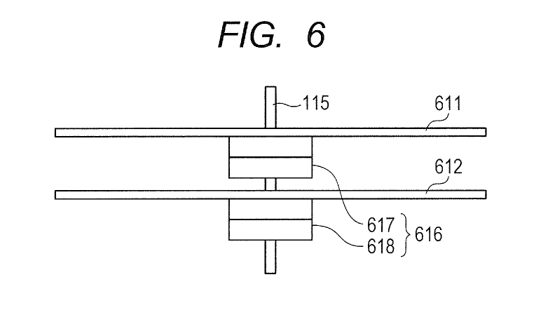

The configuration of the position adjusting mechanism 516, which independently positions M1 and M2 at a plurality of adjustment places, is not limited to the above. A mechanism, which independently performs positioning of a plurality of adjustment parts, may also be used. For example, FIG. 6 shows an example of a configuration of a position adjusting mechanism in which a plurality of the code disks 114 are provided. FIG. 6 is a view showing an example of a configuration of a position adjusting mechanism 616 when the angular encoder 113 has a first code disk 611 and a second code disk 612. The first code disk 611 corresponds to M1 as the first reflector 101, and the second code disk 612 corresponds to M2 as the first reflector 101. The position adjusting mechanism 616 is configured by a first rotational positioning mechanism 617 and a second rotational positioning mechanism 618. The first rotational positioning mechanism 617 is coupled with the shaft 115 and can rotate the first code disk 611 independently of the rotation of the shaft 115. Further, the second rotational positioning mechanism 618 is coupled with the shaft 115 and can rotate the second code disk 612 independently of the rotation of the shaft 115. With this configuration, the position adjusting mechanism 616 can independently perform positioning of the first code disk 611 and the second code disk 612 by using a plurality of combinations of the first reference position 120 and the second reference position 220.

Each of the position adjusting mechanisms 516 and 616 of the light delaying apparatus of the present embodiment independently performs adjustment for a plurality of reference positions. Therefore, the quantity of data that are handled, and the deterioration of the measurement accuracy can be suppressed in the rotary type light delaying apparatus. Further, the accuracy, at the time when information on the moving angle of the first reflector 101 is converted into information on the delaying quantity of pulse light, can be improved even when there are a plurality of reference positions.

### Embodiment 4

Embodiment 4 will be described with reference to the accompanying drawings. The present embodiment is a modification of embodiment 1. It should be noted that description of the parts in common with the previous description will be omitted.

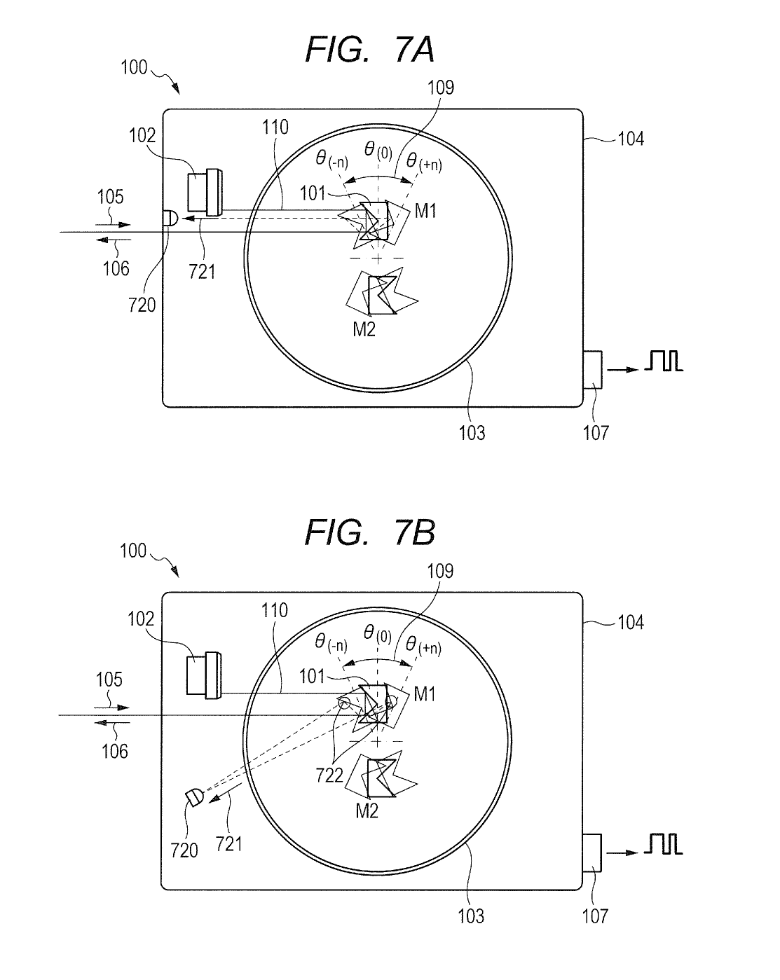

Each of FIG. 7A and FIG. 7B is a view for describing an example of a configuration of a light delaying apparatus of the present embodiment. The light delaying apparatus in FIG. 7A and FIG. 7B includes a position detector 720 which detects second emitted light (second outgoing light) 721 which propagates along the optical axis different from the optical axis of the emitted light 106. In the configuration of FIG. 7A, the position of the second reflector 102 and the position of the position detector 720 are adjusted. Specifically, when the first reflector 101 is moved to a specific position, the position of the second reflector 102 is adjusted to the position at which the turned back pulse light from the first reflector 101 is shifted from the second reflector 102. Then, the shifted pulse light is detected as the second emitted light 721 by the position detector 720. That is, the position detector 720 detects the adjusted quantity of the specific light delay.

Further, in the configuration in FIG. 7B a position detecting mechanism 722 is formed on the surface of the first reflector 101, and when the first reflector 101 is moved to a specific position, the pulse light turned back by the first reflector 101 is incident on the position detecting mechanism 722. Here, the position detecting mechanism 722 (shown by the small circle in FIG. 7B) is formed on the first reflector 101. A structure, which turns back the turned-back pulse light along the optical axis non-parallel to the optical axis of the incident light 105, is formed in the position detecting mechanism 722. The pulse light turned back along the un-parallel optical axis is detected as second emitted light 721 by the position detector 720. The position detecting mechanism 722 may be formed in the second reflector 102.

With the arrangement and configuration as described above, the light delaying apparatus 100 can detect the specific position of the first reflector 101 by the position detector 720. In other words, the adjusted quantity of the specific light delay is detectable. With the light delaying apparatus of the present embodiment, the quantity of data that are handled, and the deterioration of the measurement accuracy can be suppressed in the rotary type light delay apparatus. Further, in the light delaying apparatus of the present embodiment, the adjusted quantity of the specific light delay is detected by the position detector 720, and hence the check of the absolute position of the light delaying apparatus, and the adjustment of the reference position by the position adjustment mechanism can be easily performed.

### Embodiment 5

Embodiment 5 will be described with reference to the accompanying drawings. The present embodiment is a measurement apparatus and measurement method using the light delaying apparatus described above. It should be noted that description of the parts in common with the previous description will be omitted.

The apparatus of the present embodiment is an apparatus which measures in a time domain response of an electromagnetic wave by sampling using pulse light. For example, the apparatus of the present embodiment measures a transient response of an electromagnetic wave in a time domain. The present apparatus includes a detector which detects the momentary value of a response at the incident time of pulse light which is probe light. The light delaying apparatus described above is used as a light delaying apparatus which adjusts the light delay of the probe light. The present apparatus includes an analyzer which records a time domain response of an electromagnetic wave for each of the unit delaying quantity δL of the probe light by referring to a trigger signal output from the signal output portion 107 of the light delaying apparatus.

FIG. 8 is a view for describing a configuration of an apparatus which measures a response of an electromagnetic wave of the present embodiment. The electromagnetic wave of the apparatus is a terahertz wave 844. A light source 831 is a laser source which outputs pulse light. The pulse light typically has a pulse width from several tens to several hundred femtoseconds. The pulse light output from the light source 831 is incident on a beam splitter (BS) 839 via a mirror 836 and is branched into pump light 842 as pulse light and probe light 843 as pulse light.

A generator 832 is a generator which generates the terahertz wave 844. The terahertz wave 844 is generated in synchronization with the input pump light. The terahertz wave 844 has components of an arbitrary frequency band in the range of 0.03 THz to 30 THz. The pulse width of the terahertz wave 844 is typically several 100 femtoseconds. The terahertz wave 844 generated by the generator 832 is emitted to a sample 835 via a mirror 837. Then, for example, the terahertz wave, which is absorbed on the basis of the physical properties of the sample 835, is emitted into a detector 833 via a mirror 838. The time domain response of the terahertz wave is changed by the absorption based on the characteristics of the physical properties of the sample 835. In FIG. 8, the terahertz wave transmitted through the sample 835 is emitted into a detector 833, but the terahertz reflected by the sample 835 may be emitted into the detector 833.

The probe light 843 branched by the beam splitter (BS) 839 is converted into circularly polarized light by a polarizing beam splitter (PBS) 840 and a quarter-wave plate 841, and is incident on the light delaying apparatus 100 described above. The light delaying apparatus 100 performs adjustment of the light delay of the probe light 843, and inputs information on the adjusted quantity of light delay into the analyzer 834 via the signal output portion 107 of the light delaying apparatus 100. The probe light 843, whose light delay is adjusted, passes through the optical path the same as the optical path of the probe light 843 inputted into the light delaying apparatus 110. Then, the probe light 843 is inputted into the detector 833 via the quarter-wave plate 841 and the polarizing beam splitter (PBS).

The detector 833 is a detector that detects a momentary value of a response of a terahertz wave which is incident on the detector 833 at the time when the probe light 843 is incident on the detector 833. The incident time (the incoming time) of the probe light 843 is adjusted by the adjusted quantity of the light delay of the light delaying apparatus 100. In other words, the terahertz wave incident on the detector 833 is sampled and measured by the probe light 843. The momentary value detected by the detector 833 is inputted into the analyzer 834.

The analyzer 834 is a calculation processing portion. Specifically, the analyzer 834 records the momentary value of the detector 833 in synchronization with the trigger signal of the signal output portion 107 of the light delaying apparatus 100, which signal is output for each unit delaying quantity δL of the probe light 843. Then, the time waveform about the terahertz is constructed by converting the unit delaying quantity δL into a time length. This measuring method is referred to as THz-TDS (THz-Time Domain Spectroscopy) method. That is, the measuring apparatus of the present embodiment is a THz-TDS apparatus for acquiring a time waveform of a terahertz wave.

In the above-described apparatus and method, an electromagnetic wave to be handled is a terahertz wave. The light delaying apparatus outputs a trigger signal for each unit delaying quantity δL, and the momentary value of the response for the terahertz wave is recorded in synchronism with the trigger signal. The acquisition timing of the data about the terahertz wave is synchronized with the trigger signal output by the light delaying apparatus, and hence it is possible to prevent the conventional concern data missing, and the deterioration in measurement accuracy.

FIG. 9 is a view for describing a configuration of another embodiment of the apparatus of the present embodiment, which measures a response of an electromagnetic wave. This apparatus is an apparatus in which a response of physical properties of a sample 934 that is optically excited by pump light 940 is detected as a change in spectrum of probe light 941. For example, the apparatus of FIG. 9 measures a transient response of the physical properties. This apparatus is also referred to as a pump probe apparatus.

A light source 931 is a laser source which outputs pulse light. Typically, the pulse light has a pulse width from several tens to several hundred femtoseconds. The pulse light output from the light source 931 is inputted into a beam splitter (BS) 937 via a mirror 935, and is branched into the pump light 940 as pulse light and probe light 941 as pulse light. The pump light 940 branched by the beam splitter (BS) 937 is emitted to the sample 934 via a mirror 936 so as to optically excite the sample 934.

The probe light 941 branched by the beam splitter (BS) 937 is converted into circularly polarized light by a polarizing beam splitter (PBS) 938 and a quarter-wave plate 939, and is inputted into the light delaying apparatus 100 described above. The light delaying apparatus 100 adjusts the light delay of the probe light 941, and information on the adjusted quantity of light delay is inputted into an analyzer 933 via the signal output portion 107 of the light delaying apparatus 100. The probe light 941, whose light delay is adjusted, passes through the optical path the same as the optical path of the probe light 941 inputted into the light delaying apparatus 100. Then, via the quarter-wave plate 939 and the polarizing beam splitter (PBS) 938, the probe light 941 is emitted to the position of the sample 934, the position being the same as the position to which the pump light 940 is emitted. The spectrum of the probe light 941 is changed by physical properties of the sample 934 which is optically excited by the pump light 940. The probe light 941, after passing through the sample 934, is inputted into a detector 932.

The detector 932 is a spectroscope which detects the spectrum of the probe light 941. Specifically, the detector 932 is a detector which detects a momentary value of physical property response of the optically excited sample 934 at the incident time of the probe light 941 incident on the sample 934.

The analyzer 933 is a calculation processing portion. Specifically, in synchronization with a trigger signal of the signal output portion 107 of the light delaying apparatus 100, which signal is output for each unit delaying quantity 81 of the probe light 941, the analyzer 933 records the momentary value of the spectrum of the probe light 941 detected by the detector 932. Then, the physical property response of the sample 934 is calculated by converting the unit delaying quantity 61 into time length.

These apparatus performs the measurement by executing the following steps.

(STEP1) The first reflector 101 of the light delaying apparatus 100 is moved along the predetermined circumference.
(STEP2) The position of the first reflector 101 provided on the light delaying apparatus 100 is detected by using the reading patterns 212 in which a part of the intervals between the boundaries of the patterns is arranged irregularly. On the basis of the detection results, a trigger signal is output for each unit delaying quantity δL of the probe lights 843 and 941, each of which is pulse light. The trigger signal is inputted into each of the analyzers 834 and 933 from the signal output portion 107 of the light delaying apparatus 100.
(STEP3) In synchronization with the trigger signal, each of the analyzers 834 and 933 detects a plurality of momentary values of the responses of the electromagnetic wave (the terahertz wave 844 or the probe light 941 via the sample 934).

In the measuring apparatus and the measuring method of the present embodiments, the light delaying apparatus, having the reading patterns 212 in which a part of the intervals between the boundaries of the patterns is arranged irregularly, is used, and thereby a plurality of momentary values of time domain responses of an electromagnetic wave can be recorded for each unit delaying quantity δL. As a result, the conventionally required oversampling is not necessary, and the quantity of data to be handled can be reduced.

Especially, when a terahertz wave is used as an electromagnetic wave, in the measuring apparatus and the measuring method of the present embodiments, the light delaying apparatus outputs a trigger signal for each unit delaying quantity δL, and momentary values of responses about the terahertz wave are recorded in synchronism with the trigger signal. Therefore, acquisition timing of data about the terahertz wave are synchronized with the trigger signals output by the light delaying apparatus, thereby it is possible to prevent the conventional concern data missing and the deterioration in the measurement accuracy.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-031663, filed Feb. 20, 2015, which is hereby incorporated by reference herein in its entirety.

What is claimed is:

1. A light delaying apparatus providing a light delay, the light delaying apparatus comprising:
a first reflector configured to move along a circumference defined by a rotation center and a first radius and turn back the light along an axis parallel to an optical axis of the light incident on the first reflector;
a second reflector configured to reflect the light turned back by the first reflector such that to be coaxial with the optical axis of the light turned back by the first reflector; and
an angular encoder configured to, in order to detect the position of the first reflector on the circumference, include reading patterns in which at least a part of intervals between boundaries of the reading patterns is arranged irregularly, wherein
the interval between the boundaries of the reading patterns corresponds to an adjusted quantity of the light delay converted from a time interval during which a time domain response of an electromagnetic wave is measured by using the light reflected by the second reflector.

2. The light delaying apparatus according to claim 1, wherein the adjusted quantity converted from the time interval is a unit delaying quantity, and the intervals between the boundaries of the reading patterns correspond to the unit delaying quantity.

3. The light delaying apparatus according to claim 2, wherein, when the response is in a form of a terahertz wave of a maximum frequency F, the unit delaying quantity determined by the reading pattern and the acceptable range of the error of the time interval are respectively expressed as A<1/(2F) and B<C/(2F), where time accuracy is represented by A, accuracy of the unit delaying quantity is represented by B, and an optical constant is represented by C, and shapes of the reading pattern is formed to have an accuracy satisfying these conditions, and
when the position accuracy of the turning back optical system including the first reflector and the second reflector is set as D, the turning back optical system is provided so as to satisfy the expression D<C/(4F).

4. The light delaying apparatus according to claim 2, wherein, when a transient response, as the response, is observed with time resolution T, the unit delaying quantity determined by the reading patterns and the acceptable range of the error of the time interval are respectively expressed as A<T and B<CA, where time accuracy is represented by A, accuracy of unit delaying quantity is represented by B, and an optical constant is represented by C, and shapes of the reading patterns are formed to have accuracy satisfying these conditions; and
when position accuracy of the turning back optical system including the first reflector and the second reflector is set as D, the turning back optical system is provided so as to satisfy the expression D<CA/2.

5. The light delaying apparatus according to claim 2, wherein, when the response is represented by a form of tomography about an observation of an object, the acceptable range of the error of the unit delaying quantity determined by the reading patterns is expressed as B<E, where accuracy of the unit delaying quantity is represented by B, and spatial resolution is represented by E, and shapes of the reading patterns are formed to have accuracy satisfying this condition; and
when position accuracy of the turning back optical system including the first reflector and the second reflector is set as D, the turning back optical system is provided so as to satisfy the expression D<E/2.

6. The light delaying apparatus according to claim 2, wherein θ₍ᵢ₎ which is a position of the first reflector on the circumference is expressed as
θ₍ᵢ₎=sin⁻¹{(iδL)/(4R)}i=0,1, . . . ,n,
where the unit delaying quantity is represented by δL, the first radius is represented by R, and the number of data configuring the response is represented by n, and
the reading patterns include a first phase pattern whose interval W between the boundaries is defined by the following expression on the basis of the reference position,
W₍ⱼ₎=(πr/180)·(θ₍ₓ₍ⱼ₊₁₎₎−θ₍ₓⱼ₎)j=0,1, . . . ,(n/x−1)
where a second radius which defines a formation position on a code disk of the reading patterns is represented by r, and the number of phases of the reading patterns is represented by x.

7. The light delaying apparatus according to claim 6, wherein, when a constant is set as m, the first phase pattern is represented as A phase, and the other phases are respectively set such that B phase is represented as m=1, C phase is represented as m=2, D phase is represented as m=3, the boundaries of the patterns of the other phases are arranged to be shifted at an interval d relative to the position of the boundary of the pattern of the first phase on the basis of the reference position of each phase, the interval d being expressed as follow.
d₍ⱼ₎₍ₘ₎=(πr/180)·(θ₍ₓⱼ₊ₘ₎−θ₍ₓⱼ₎)m=1,2, . . . ,x

8. The light delaying apparatus according to claim 1, comprising a position adjusting mechanism configured to perform relative positioning between a first reference position of the first reflector arranged on the circumference and a second reference position of each reading pattern.

9. The light delaying apparatus according to claim 8, wherein the position adjusting mechanism includes a mechanism which independently adjusts a plurality of adjustment places at which positioning of the first reference position and the second reference position is performed.

10. The light delaying apparatus according to claim 1, comprising a position detector configured to detect second light passing along an optical axis different from the optical axis of the light reflected by the second reflector,
wherein the position detector detects an adjusted quantity of specific light delay.

11. The light delaying apparatus according to claim 1, wherein the angular encoder outputs a trigger signal in response to detection of each of a plurality of positions of the first reflector.

12. A measuring apparatus which measures a time domain response of an electromagnetic wave by sampling using light, the measuring apparatus comprising:
a detector which detects a momentary value of a response at the incident time of the light as probe light;
a light delaying apparatus providing a light delay of the light; and
an analyzer which records time domain responses of the electromagnetic wave for each unit delaying quantity of the probe light with references to a trigger signal output by the light delaying apparatus, wherein
the light delaying apparatus comprising:
a first reflector configured to move along a circumference defined by a rotation center and a first radius and turn back the light along an axis parallel to an optical axis of the light incident on the first reflector;
a second reflector configured to reflect the light turned back by the first reflector such that to be coaxial with the optical axis of the light turned back by th first reflector; and
an angular encoder configured to, in order to detect the position of the first reflector on the circumference, include reading patterns in which at least a part of intervals between boundaries of the reading patterns is arranged irregularly, wherein
the interval between the boundaries of the reading patterns corresponds to an adjusted quantity of the light delay converted from a time interval during which a time domain response of an electromagnetic wave is measured by using the light reflected by the second reflector.

13. The measuring apparatus according to claim 12, wherein the electromagnetic wave is a terahertz wave.

14. A method for measuring a time domain response of an electromagnetic wave by sampling using light, the method comprising:
a step of moving a first reflector along a circumference defined by a rotation center and a first diameter, the first reflector being movable along the circumference and turning back the light as incident light along an axis parallel to an optical axis of the light incident on the first reflector;
a step of detecting a position of the first reflector on the circumference by using reading patterns in which at least a part of intervals between boundaries of the reading patterns is arranged irregularly in order to detect the position of the first reflector;
a step of, on the basis of the detection result in the step of detecting the position of the first reflector, outputting a trigger signal for each unit delaying quantity of light delay of the light, the light delay being caused by the movement of the first reflector; and
a step of, in synchronism with the trigger signal, detecting a momentary value of a response of the electromagnetic wave for each time interval corresponding to the unit delaying quantity.
